(19) United States
(12) Patent Application Publication
(10) Pub. No.: US 2022/0134850 A1
(43) Pub. Date: May 5, 2022

(54) VEHICLE SUN VISOR HAVING AN ELECTRICAL CONNECTION ASSEMBLY

(71) Applicant: Daimay France SAS, Creutzwald (FR)

(72) Inventors: Frédéric Selvini, Falck (FR); Patrick Welter, Lachambre (FR)

(21) Appl. No.: 17/431,648

(22) PCT Filed: Feb. 19, 2020
(86) PCT No.: PCT/EP2020/054350

§ 371 Date: Aug. 17, 2021

(30) Foreign Application Priority Data
Feb. 20, 2019 (EP) 19305206.5

(51) Int. Cl. B60J 3/02

(52) U.S. Cl. CPC B60J 3/0278; B60J 3/0282

(57) ABSTRACT

A vehicle sun visor (14) includes a rod assembly (22) and a body (20) configured to rotate about the rod assembly. The vehicle sun visor also includes an electrical connection assembly (18) having a first electrical connector (34) disposed about at least a portion of a periphery of the rod assembly along a circumferential axis of the rod assembly. The electrical connection assembly also includes a second electrical connector (36) coupled to the body and having multiple fingers (44). The fingers are biased toward the first electrical connector (34) to establish contact between the first electrical connector and the second electrical connector, and the fingers (44) are offset from one another along the circumferential axis of the rod assembly, such that at least one finger contacts the first electrical connector throughout a rotational range of motion of the body about the rod assembly.

### BACKGROUND

The disclosure relates generally to a vehicle sun visor having an electrical connection assembly.

Many vehicles employ sun visors to shield occupants from sunlight, thereby enabling the occupants to focus on the surrounding environment. For example, certain vehicles include sun visors positioned adjacent to a top portion of the windshield. Under certain lighting conditions, an occupant (e.g., the driver) may deploy the sun visor (e.g., by rotating the sun visor body about a rotational axis from a storage position to a deployed position) to reduce light transmission into the vehicle interior, thereby enabling the driver to focus on vehicle operations.

Certain sun visors include a vanity mirror and a lighting system configured to illuminate a vehicle occupant, thereby enabling the vehicle occupant to view a reflection in the vanity mirror during low light conditions. In certain sun visors, the lighting system receives electrical power from the vehicle electrical system (e.g., from the main battery of the vehicle). In such sun visors, the sun visor may include an electrical connection assembly that supplies electrical power to the lighting system while the sun visor body is in the deployed position and interrupts electrical power to the lighting system while the sun visor body is in the storage position. For example, the sun visor may include a rod assembly, the rod assembly may include first electrodes, and the body may include second electrodes. While the sun visor body is in the deployed position, the first and second electrodes may be aligned to establish an electrical connection between the lighting system and the vehicle electrical system, and while the sun visor body is in the storage position, the first and second electrodes may be offset to interrupt the electrical connection between the lighting system and the vehicle electrical system. Unfortunately, such an electrical connection assembly may not supply electrical power to other electrical components of the sun visor (e.g., an ambient light, a remote door opener, etc.) while the sun visor is in the storage position.

### BRIEF DESCRIPTION

In certain embodiments, a vehicle sun visor includes a rod assembly and a body configured to rotate about the rod assembly. The vehicle sun visor also includes an electrical connection assembly having a first electrical connector disposed about at least a portion of a periphery of the rod assembly along a circumferential axis of the rod assembly. The electrical connection assembly also includes a second electrical connector coupled to the body and having multiple fingers. The fingers are biased toward the first electrical connector to establish contact between the first electrical connector and the second electrical connector, and the fingers are offset from one another along the circumferential axis of the rod assembly, such that at least one finger contacts the first electrical connector throughout a rotational range of motion of the body about the rod assembly.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of a vehicle that may include at least one sun visor having an electrical connection assembly;

FIG. 2 is a perspective view of a part of the interior of the vehicle of FIG. 1;

FIG. 3 is a perspective view of an embodiment of a sun visor having an electrical connection assembly;

FIG. 4 is a perspective view of a portion of the sun visor of FIG. 3 having the electrical connection assembly;

FIG. 5 is an exploded view of the electrical connection assembly of FIG. 3;

FIG. 6 is a perspective view of a portion of another embodiment of a sun visor having an electrical connection assembly;

FIG. 7 is a perspective view of the portion of the sun visor of FIG. 6, in which a sleeve is molded over a cap of the sun visor;

FIG. 8 is a perspective view of the portion of the sun visor of FIG. 6, in which second electrical connectors of the electrical connection assembly are disposed around the sleeve; and

FIG. 9 is a perspective view of a portion of a further embodiment of a sun visor having an electrical connection assembly.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

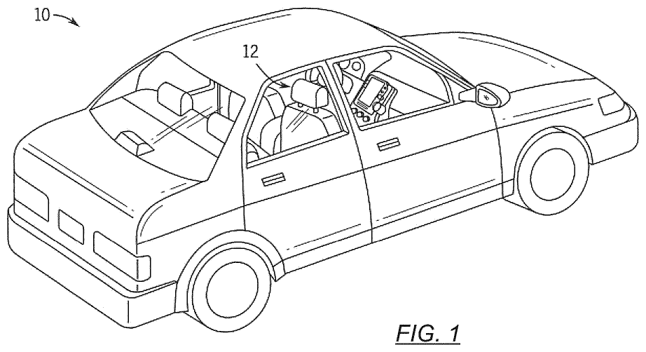

FIG. 1 is a perspective view of an embodiment of a vehicle 10 that may include at least one sun visor having an electrical connection assembly. The sun visor(s) are positioned within an interior 12 of the vehicle 10 to shield vehicle occupant(s) from sunlight. At least one sun visor may include various electrical component that receive electrical power from a vehicle electrical system (e.g., from the main battery of the vehicle). For example, the sun visor may include a lighting system configured to illuminate a vehicle occupant, thereby enabling the vehicle occupant to view a reflection in a vanity mirror of the sun visor during low light conditions. The sun visor may also include an ambient light, a remote door opener, other electrical components, or a combination thereof.

The sun visor may include an electrical connection assembly configured to establish an electrical connection between the vehicle electrical system and the electrical components of the sun visor. For example, the sun visor may include a body and a rod assembly. The rod assembly may be coupled to a structure of the vehicle (e.g., a roof panel, an interior panel, etc.) via a mounting assembly. In addition, the sun visor body may be pivotally coupled to the rod assembly, thereby enabling the sun visor body to rotate between a deployed position and a storage position. In certain embodiments, the electrical connection assembly includes a first electrical connector disposed about at least a portion of the periphery of the rod assembly along a circumferential axis of the rod assembly. In addition, the electrical connection assembly includes a second electrical connector coupled to the body and having multiple fingers. The fingers are biased toward the first electrical connector to establish contact between the first electrical connector and the second electrical connector, and the fingers are offset from one another along the circumferential axis of the rod assembly, such that at least one finger contacts the first electrical connector throughout a rotational range of motion of the body about the rod assembly (e.g., between the deployed position and the storage position). Accordingly, the electrical components of the sun visor may receive electrical power from the vehicle electrical system regardless of the orientation of the sun visor body.

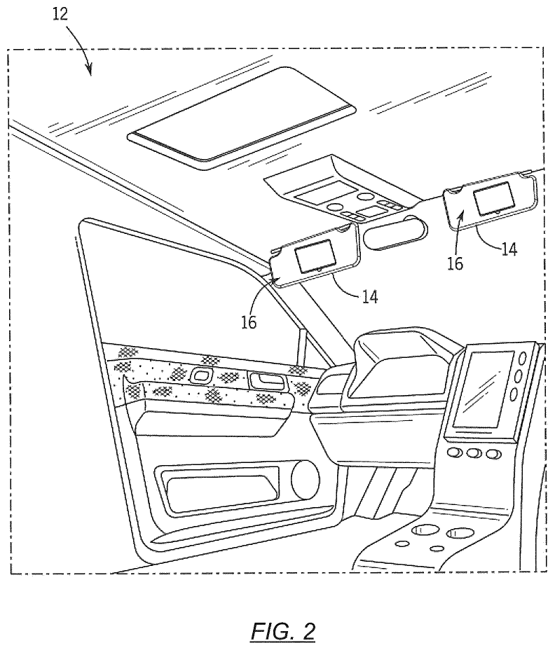

FIG. 2 is a perspective view of a part of the interior of the vehicle of FIG. 1. In the illustrated embodiment, the vehicle interior 12 includes a sun visor 14 having a vanity mirror assembly 16. The vanity mirror assembly may include a mirror and a cover disposed over the mirror. A vehicle occupant may open the cover (e.g., via rotation of the cover or translation of the cover) to expose the mirror and close the cover (e.g., via rotation of the cover or translation of the cover) to conceal the mirror. In certain embodiments, the sun visor 14 (e.g., the vanity mirror assembly 16 of the sun visor 14) may include a lighting system configured to illuminate a vehicle occupant, thereby enabling the vehicle occupant to view a reflection in the vanity mirror during low light conditions. For example, the lighting system may include a switch configured to activate a light source while the cover is open and to deactivate the light source while the cover is closed. As discussed in detail below, the sun visor 14 may include an electrical connection assembly configured to supply electrical power from the vehicle electrical system to the lighting system, as well as to other electrical components of the sun visor.

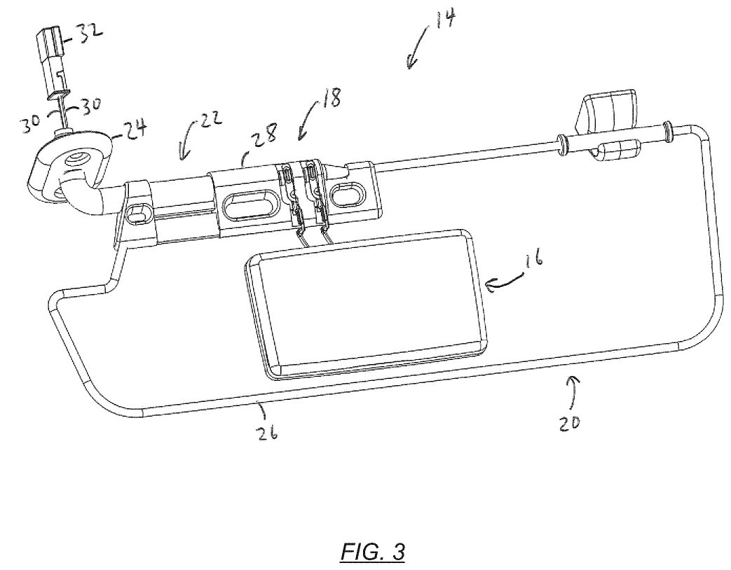

FIG. 3 is a perspective view of an embodiment of a sun visor 14 having an electrical connection assembly 18. In the illustrated embodiment, the sun visor 14 has a body 20 and a rod assembly 22. The rod assembly 22 is configured to couple to a structure of the vehicle (e.g., a roof panel, an interior panel, etc.) via a mounting assembly 24. In addition, the body 20 of the sun visor 14 is configured to rotate about the rod assembly 22, thereby enabling the sun visor body 20 transition between a deployed position (e.g., a position that reduces light transmission into the vehicle interior) and a storage position (e.g., parallel to the roof/interior roof panel of the vehicle). In the illustrated embodiment, the body 20 includes a wire frame 26 and a mount 28. The wire frame 26 is coupled to the mount 28, and the mount 28 is pivotally coupled to the rod assembly 22. In certain embodiments, a core (e.g., a foam core, a polymer core, etc.) is coupled to the wire frame 26 and/or to the mount 28, and a cover (e.g., fabric cover, etc.) is disposed about the core. In addition, the vanity mirror assembly 16 may be coupled to the wire frame 26 (e.g., via the core). While the sun visor body 20 includes the wire frame 26 and the mount 28 in the illustrated embodiment, in other embodiments, the sun visor body may be formed from any other suitable structure (e.g., a polymeric structure, etc.). Furthermore, while the mount 28 is rigidly coupled to the wire frame 26 in the illustrated embodiment, in other embodiments, the frame may include a tube, and the mount may be slidably disposed within the tube to establish a sun visor body that slides with respect to the mount/rod assembly.

As discussed in detail below, the electrical connection assembly 18 includes first electrical connectors each disposed about at least a portion of a periphery (e.g., circumference) of the rod assembly 22. The electrical connection assembly 18 also includes second electrical connectors coupled to the body 20, in which each second electrical connector has multiple fingers. The fingers are biased toward a respective first electrical connector to establish contact between the first electrical connector and the second electrical connector. In addition, the fingers are offset from one another along a circumferential axis of the rod assembly 22, such that at least one finger contacts the respective first electrical connector throughout a rotational range of motion of the body 20 (e.g., between the deployed position and the storage position). Furthermore, an electrical wire 30 is electrically coupled to each first electrical connector, and each electrical wire 30 extends through the rod assembly 22. In the illustrated embodiment, a plug 32 is electrically coupled to the electrical wires 30, and the plug 32 is configured to interface with a corresponding plug of the vehicle electrical system, thereby establishing an electrical connection between the vehicle electrical system and the first electrical connectors. Because the first electrical connectors maintain contact with the second electrical connectors throughout the rotational range of motion of the body 20, electrical components coupled to body, which are electrically coupled to the second electrical connectors, may receive electrical power throughout the range of motion of the body 20. In the illustrated embodiment, the second electrical connectors are electrically coupled to the lighting system of the vanity mirror assembly 16. Accordingly, the lighting system may receive electrical power from the vehicle electrical system throughout the range of motion of the body 20. Additionally or alternatively, other electrical components, such as an ambient light, a remote door opener, among others, may be electrically coupled to the second electrical connectors. As a result, each electrical component coupled to the body may receive electrical power from the vehicle electrical system throughout the rotational range of motion of the body.

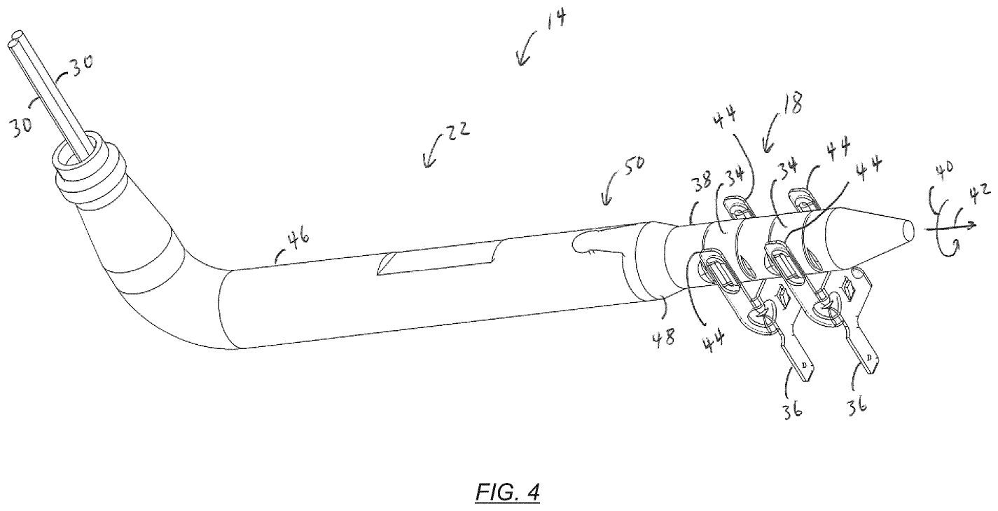

FIG. 4 is a perspective view of a portion of the sun visor 14 of FIG. 3 having the electrical connection assembly 18. In the illustrated embodiment, the electrical connection assembly 18 includes two first electrical connectors 34 and two second electrical connectors 36. As illustrated, the first electrical connectors 34 are disposed about at least a portion of a periphery 38 (e.g., circumference) of the rod assembly 22 along a circumferential axis 40 of the rod assembly 22. For example, each first electrical connector 34 may extend about 30 degrees to about 360 degrees, about 45 degrees to about 330 degrees, about 60 degrees to about 300 degrees, or about 90 degrees to about 270 degrees about the circumferential axis 40. In certain embodiments, the first electrical connectors may have the same circumferential extents, or at least one first electrical connector may have a different circumferential extent than at least one other first electrical connector. As illustrated, the first electrical connectors 34 are spaced apart from one another along a longitudinal axis 42 of the rod assembly 22 to substantially reduce or eliminate the possibility of electrical contact between the first electrical connectors 34. Furthermore, each first electrical connector may have any suitable extent along the longitudinal axis 42 that facilitates contact with a respective second electrical connector 36.

Furthermore, the second electrical connectors 36 are coupled to the body of the sun visor 14 (e.g., to the mount of the body). In addition, each second electrical connector has multiple fingers 44. The fingers 44 of each second electrical connector 36 are biased toward a respective first electrical connector 34 to establish contact between the second electrical connector 36 and the respective first electrical connector 34. The fingers 44 are also offset from one another along the circumferential axis 40, such that at least one finger 44 contacts the respective first electrical connector throughout the rotational range of motion of the body about the rod assembly 22. For example, in the illustrated embodiment, the fingers 44 of each second electrical connector 36 are offset about 180 degrees from one another along the circumferential axis 40, such that the two fingers are positioned on opposite sides of the respective first electrical connector. Accordingly, at least one finger may maintain contact with a respective first electrical connector having a circumferential extent of more than 180 degrees (e.g., assuming that the rotational range of motion of the body is 360 degrees). However, if a first electrical connector having a circumferential extent of less than 180 degrees were coupled to the rod assembly, the respective second electrical connector may include additional fingers to establish an electrical connection between the first and second electrical connectors throughout the rotational range of motion of the body (e.g., assuming that the rotational range of motion of the body is 360 degrees). For example, while each second electrical connector has two fingers in the illustrated embodiment, in other embodiments, at least one second electrical connector may include additional figures (e.g., 3, 4, 5, 6, 7, 8, 9, 10, or more).

While the electrical connection assembly includes two first electrical connectors 34 and two second electrical connectors 36 in the illustrated embodiment, in other embodiments, the electrical connection assembly may include more or fewer first and second electrical connectors. For example, in certain embodiments, the electrical connection assembly may include 1, 2, 3, 4, 5, 6, 7, 8, or more first electrical connectors and a corresponding number of second electrical connectors. In addition, the spacing between the second electrical connectors 36 along the longitudinal axis 42 may be particularly selected to facilitate longitudinal alignment between the first electrical connectors and the second electrical connectors.

In the illustrated embodiment, the rod assembly 22 includes an arm 46 and a cap 48 coupled to the arm 46. In the illustrated embodiment, the cap 48 is coupled to the arm 46 by a locking assembly 50. However, in other embodiments, the cap may be coupled to the arm by any suitable attachment system (e.g., fastener(s), adhesive, etc.). In the illustrated embodiment, the first electrical connectors 34 are coupled to the cap 48. However, in other embodiments, at least one of the first electrical connectors (e.g., all of the first electrical connectors) may be coupled to the arm. In certain embodiments, at least one first electrical connector may be molded to the rod assembly (e.g., to the cap of the rod assembly). For example, the first electrical connector(s) may be electrically coupled to respective wire(s) and then disposed in a mold cavity at desired location(s). A flowable polymeric material may then be directed (e.g., injected) into the mold cavity, thereby forming the cap with the first electrical connector(s) coupled to the cap and disposed about at least a portion of the periphery of the cap along the circumferential axis. In certain embodiments, the first electrical connector(s) may expand radially outward during the molding process, thereby driving the first electrical connector(s) against the wall of the mold. As a result, the shape of the first electrical connector(s) may be precisely controlled (e.g., to establish substantially round first electrical connector(s)). The electrical wires may then be directed through the arm of the rod assembly, and the cap may be coupled to the arm. In further embodiments, the cap may be formed (e.g., by an injection molding process) and then the first electrical connector(s) may be coupled to the cap (e.g., by a crimping process, by an adhesive connection, by fastener(s), etc.). Furthermore, in certain embodiments, the cap and the arm may be formed as a single piece, and the first electrical connector(s) may be coupled to the rod assembly (e.g., during a molding process of the rod assembly or after the rod assembly is formed).

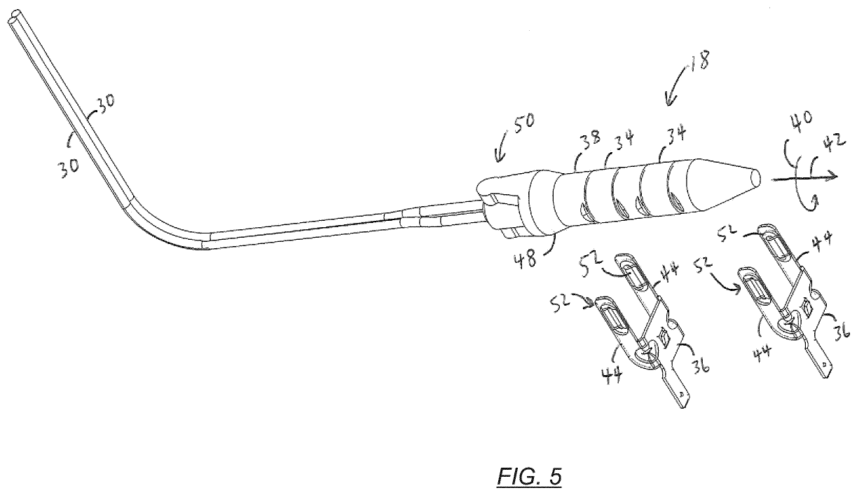

FIG. 5 is an exploded view of the electrical connection assembly 18 of FIG. 3. In the illustrated embodiment, the fingers 44 of each second electrical connector 36 are formed from a single piece of electrically conductive material (e.g., metal, etc.). For example, at least one second electrical connector 36 may be formed by a stamping processing, in which a single flat piece of material (e.g., metal) is bent and/or cut into the desired shape of the second electrical connector 36 (e.g., having two opposed fingers 44). However, in further embodiments, at least one second electrical connector may be formed by any other suitable technique (e.g., coupling multiple components to one another to form the second electrical connector).

In the illustrated embodiment, each finger 44 of the second electrical connectors 36 has a respective protrusion 52. The protrusions 52 are configured to contact a respective first electrical connector 34, thereby establishing an electrical connection between the first and second electrical connectors. Each protrusion may have any suitable shape to facilitate contact between the respective finger and the first electrical connector. While each finger has one protrusion in the illustrated embodiment, in other embodiments, at least one finger may have more or fewer protrusion (e.g., 1, 2, 3, 4, 5, 6, etc.). For example, the protrusion may be omitted from at least one finger.

Because the fingers 44 of the second electrical connectors 36 are biased toward the respective first electrical connectors 34 and because the fingers 44 of each second electrical connector 36 are positioned on opposite sides of the respective first electrical connector 34, the fingers 44 compress the respective first electrical connector. As a result, contact between the electrical connectors may be maintained as the sun visor body rotates about the rod assembly, thereby enabling a significant amount of electrical power to be transferred through the electrical connection assembly 18 (e.g., while substantially reducing electrical power loss, which may result from an interrupted or inconsistent connection between the electrical connectors).

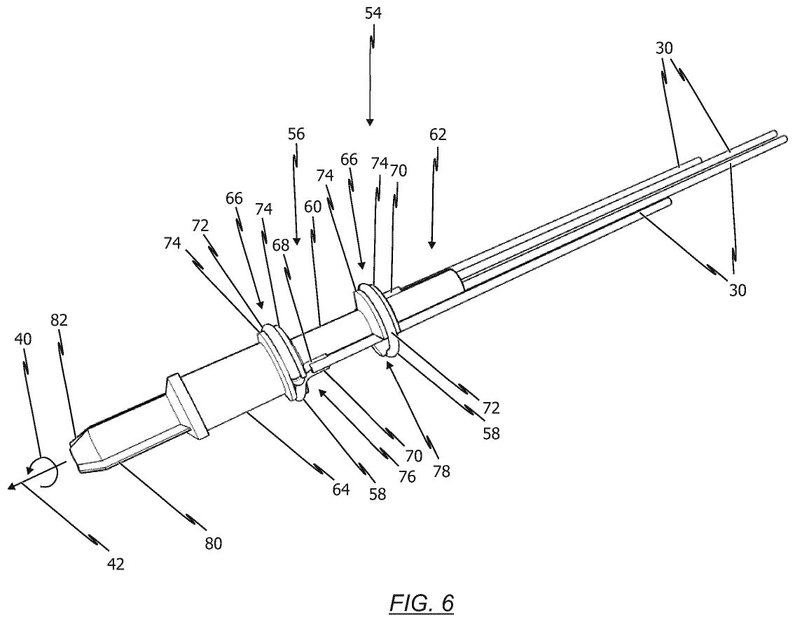

FIG. 6 is a perspective view of a portion of another embodiment of a sun visor 54 having an electrical connection assembly 56. In the illustrated embodiment, the electrical connection assembly 56 includes first electrical connectors 58 disposed about at least a portion of a periphery 60 of a rod assembly 62 along the circumferential axis 40. In the illustrated embodiment, the rod assembly 62 includes an arm and a cap 64 coupled to the arm. However, in other embodiments, the rod assembly may be formed as a single structure (e.g., in which the cap and arm are integrated into the single structure). In the illustrated embodiment, the cap 64 of the rod assembly 62 has two recesses 66, and a respective first electrical connector 58 is disposed within each recess 66. As illustrated, each recess 66 is formed within a respective circumferential protrusion of the cap 64. However, in other embodiments, at least one recess may be formed within any suitable portion of the cap (e.g., at least one respective circumferential protrusion may be omitted). Furthermore, in certain embodiments, at least one first electrical connector may be coupled to the arm (e.g., disposed within a recess of the arm).

In the illustrated embodiment, each first electrical connector 58 is formed from a bent wire having a first longitudinal extension 68, a second longitudinal extension 70, and a circumferential portion 72. The circumferential portion 72 extends about the circumferential axis 40 from the first longitudinal extension 68 to the second longitudinal extension 70. Accordingly, each first electrical connector 58 may flex along the circumferential axis 40 to establish a gap between the first and second longitudinal extensions (e.g., while a force driving the first and second longitudinal extensions is applied to the first electrical connector 58 along the circumferential axis 40). As a result, each first electrical connector 58 may be coupled to the rod assembly 62 (e.g., to the cap 64 of the rod assembly 62) by applying a force to the first electrical connector 58 along the circumferential axis 40 to expand the gap between the longitudinal extensions. The first electrical connector 58 may then be disposed within the recess, and the force may be removed, thereby enabling the first electrical connector to contract to couple the first electrical connector to the rod assembly. While each first electrical connector is formed from a bent wire in the illustrated embodiment, in other embodiments, at least one first electrical connector may be formed by any other suitable structure.

In the illustrated embodiment, each recess 66 is formed between a pair of opposing circumferential ridges 74 (e.g., the ridges 74 are positioned on opposite sides of the circumferential portion 72 of the respective first electrical connector 58). In addition, at least one circumferential ridge 74 has a gap 76, and the longitudinal extensions of the respective first electrical connector 58 extend through the gap 76. Accordingly, the gap accommodates the longitudinal extensions of the respective first electrical connector. In the illustrated embodiment, an electrical wire 30 is coupled to at least one longitudinal extension of each first electrical connector 58 (e.g., via a soldered connection, a crimped connection, etc.), thereby establishing an electrical connection between the electrical wire and the first electrical connector. Furthermore, in certain embodiments, the cap may include a longitudinal recess configured to accommodate the electrical wire. In addition, at least one circumferential protrusion may include a notch 78 configured to accommodate an electrical wire. While each first electrical connector includes two longitudinal extensions in the illustrated embodiment, in other embodiments, at least one first electrical connector may include more or fewer longitudinal extensions.

In the illustrated embodiment, the sun visor 54 includes a third electrical connector 80 and a fourth electrical connector 82. The third and fourth electrical connectors are configured to engage respective electrical connectors coupled to the sun visor body while the sun visor body is in the deployed position, and the third and fourth electrical connectors are configured to disengage the respective electrical connectors of the sun visor body while the sun visor body is in the storage position. As illustrated, an electrical wire 30 is coupled to the third electrical connector 80, and an electrical wire 30 is coupled to the fourth electrical connector 82. The electrical wires may electrically couple the third and fourth electrical connectors to the vehicle electrical system (e.g., to the main battery of the vehicle), and the respective electrical connectors may be electrically coupled to the lighting system of the vanity mirror assembly. Accordingly, while the sun visor body is in the deployed position, an electrical connection between the vehicle electrical system and the lighting system is established, and while the sun visor body is in the storage position, the electrical connection between the vehicle electrical system and the lighting system is terminated. As a result, the lighting system is disabled while the sun visor body is in the storage position.

In certain embodiments, the cap 64 may be formed by a molding process. For example, the third and fourth electrical connectors may be electrically coupled to respective wires and then disposed into a mold cavity at a desired location. A flowable polymeric material may then be directed (e.g., injected) into the mold cavity, thereby forming the cap with the third and fourth electrical connectors coupled to the cap. The first electrical connectors 58 may be coupled to the cap 64 (e.g., via the process described above). The electrical wires may then be directed through the arm of the rod assembly, and the cap may be coupled to the arm. In further embodiments, the cap may be formed (e.g., by an injection molding process) and then the third and fourth electrical connectors may be coupled to the cap (e.g., by an adhesive connection, by fastener(s), etc.). Furthermore, in certain embodiments, the cap and the arm may be formed as a single piece, and the third and fourth electrical connectors may be coupled to the rod assembly (e.g., during a molding process of the rod assembly or after the rod assembly is formed).

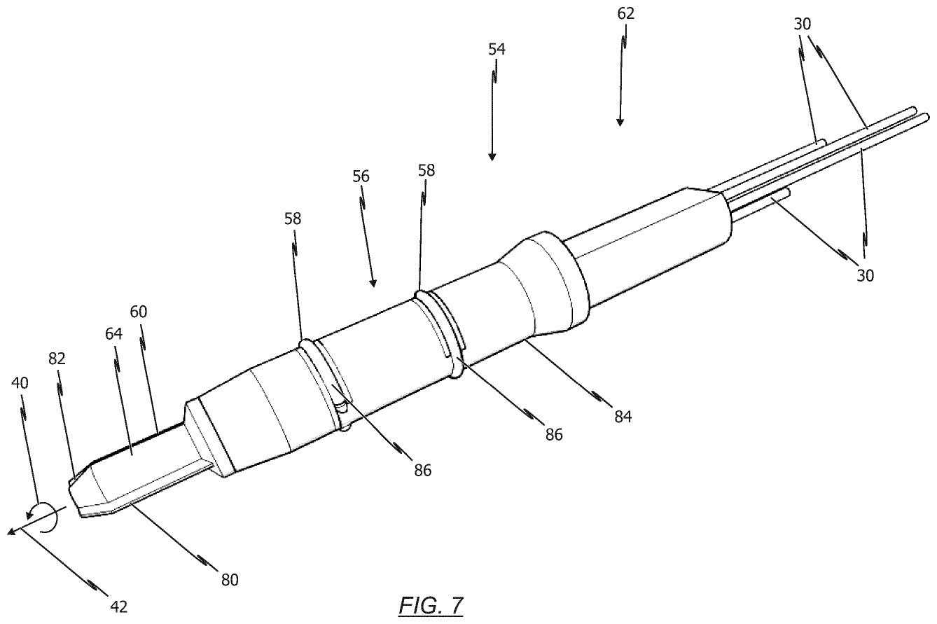

FIG. 7 is a perspective view of the portion of the sun visor 54 of FIG. 6, in which a sleeve 84 is molded over the cap 64 of the sun visor 54. For example, the cap 64 with the electrical connectors attached, as shown in FIG. 6, may be disposed within a mold cavity and polymeric material may be directed (e.g., injected) into the mold cavity, thereby forming the sleeve 84. As illustrated, the sleeve 84 does not cover the outer peripheral surfaces 86 of the first electrical connectors 58. As a result, an electrical connection between the first electrical connectors and the second electrical connectors may be established. While the sleeve is formed by molding over the cap in the illustrated embodiment, in other embodiments, the sleeve may be formed separately and coupled to the cap. In further embodiments, the sleeve may be omitted.

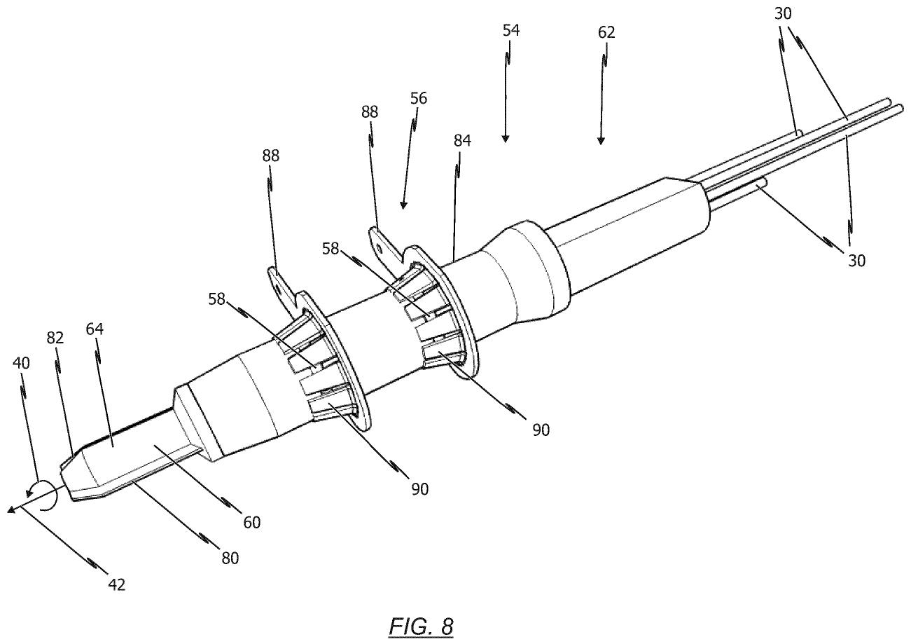

FIG. 8 is a perspective view of the portion of the sun visor 54 of FIG. 6, in which second electrical connectors 88 of the electrical connection assembly 56 are disposed around the sleeve 84. The second electrical connectors 88 are coupled to the body of the sun visor 54, and each second electrical connector 88 has multiple fingers 90. The fingers 90 of each second electrical connector 88 are biased toward the respective first electrical connector 58 to establish contact between the second electrical connector and the respective first electrical connector. In addition, the fingers 90 of each second electrical connector 88 are offset from one another along the circumferential axis 40, such that at least one finger contacts the respective first electrical connector 58 throughout a rotational range of motion of the body about the rod assembly 62. Because the first electrical connectors 58 maintain contact with the second electrical connectors 88 throughout the rotational range of motion of the body, electrical components coupled to the body, which are electrically coupled to the second electrical connectors, may receive electrical power throughout the range of motion of the body. Accordingly, while the sun visor body is in the storage position, the lighting system of the vanity mirror assembly may be disabled, but other electrical components (e.g., an ambient light, a remote door opener, etc.), which are electrically coupled to the second electrical connectors, may receive electrical power from the vehicle electrical system.

In the illustrated embodiment, the fingers 90 of each second electrical connector 88 are formed from a single piece of electrically conductive material (e.g., metal, etc.). For example, at least one second electrical connector 88 may be formed by a stamping processing, in which a single flat piece of material (e.g., metal) is bent and/or cut into the desired shape of the second electrical connector 88 (e.g., having multiple circumferentially spaced fingers). However, in further embodiments, at least one second electrical connector may be formed by any other suitable technique (e.g., coupling multiple components to one another to form the second electrical connector).

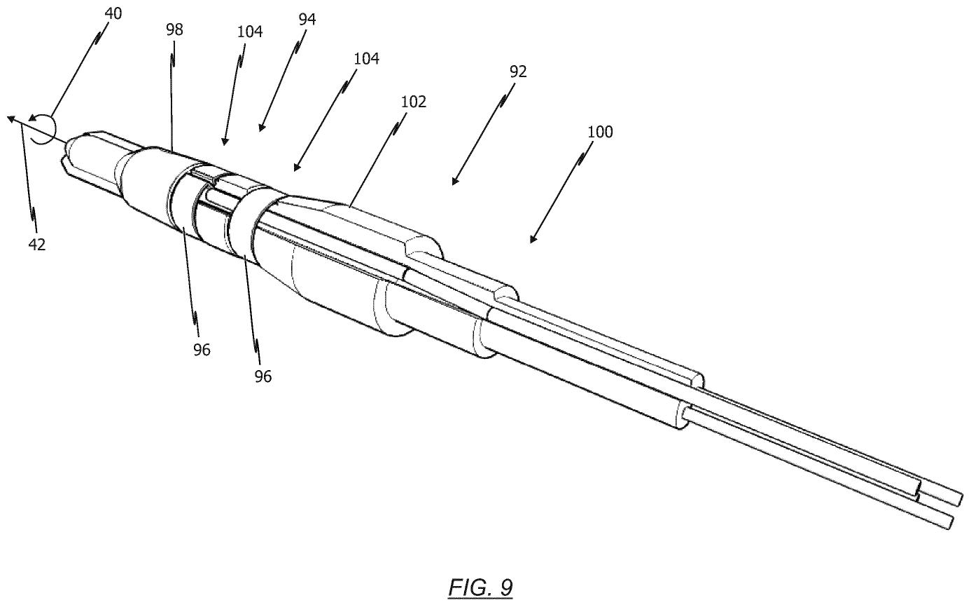

FIG. 9 is a perspective view of a portion of a further embodiment of a sun visor 92 having an electrical connection assembly 94. In the illustrated embodiment, the electrical connection assembly 94 includes first electrical connectors 96 disposed about at least a portion of a periphery 98 of a rod assembly 100 along the circumferential axis 40. In the illustrated embodiment, the rod assembly 100 includes an arm and a cap 102 coupled to the arm. However, in other embodiments, the rod assembly may be formed as a single structure (e.g., in which the cap and arm are integrated into the single structure). In the illustrated embodiment, the cap 102 of the rod assembly 100 has two recesses 104, and a respective first electrical connector 96 is disposed within each recess 104. While each first electrical connector 96 is coupled to the cap 102 in the illustrated embodiment, in other embodiments, at least one first electrical connector may be coupled to the arm (e.g., disposed within a recess of the arm).

In the illustrated embodiment, each first electrical connector 96 is crimped (e.g., radially compressed and/or circumferentially compressed) to secure/couple the first electrical connector 96 to the cap 102 of the rod assembly 100. However, in other embodiments, at least one first electrical connector may be coupled to the rod assembly by another suitable technique. Furthermore, in the illustrated embodiment, at least one first electrical connector includes a longitudinal extension, and a respective electrical wire is electrically coupled to the longitudinal extension. However, in other embodiments, the electrical wire may be coupled to a body of the first electrical connector (e.g., the longitudinal extension may be omitted).

Any of the features disclosed with regard to one embodiment may be employed within other embodiments, where suitable. For example, the sun visor assembly disclosed with reference to FIGS. 3-5 may include third and fourth electrical connectors to selectively provide electrical power to a lighting system of a vanity mirror assembly. Furthermore, any of the variations disclosed with regard to one embodiment (e.g., the number of electrical connectors, the circumferential extent of the electrical connectors, the number of fingers, etc.) may be applied to the other embodiments, where suitable. In addition, any of the manufacturing methods described with regard to one embodiment (e.g., molding, stamping, etc.) may be applied to the other embodiments, where suitable. Also, any of the functionality of the elements described with regard to one embodiment (e.g., the functionality of the rod assembly, the functionality of one or more electrical connectors, etc.) may be applied to the corresponding elements of the other embodiments, where suitable.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A vehicle sun visor, comprising:
a rod assembly;
a body configured to rotate about the rod assembly;
wherein the body is configured to transition between a deployed position and a storage position when the rod assembly is coupled to a vehicle; and
an electrical connection assembly, comprising:
a first electrical connector disposed about 30 degrees to about 360 degrees about a circumference of the rod assembly along a circumferential axis of the rod assembly;
a second electrical connector coupled to the body;
wherein the second electrical connecter comprises a plurality of fingers,
wherein the plurality of fingers are biased toward the first electrical connector to establish contact between the first electrical connector and the second electrical connector, and
wherein the plurality of fingers are offset from one another along the circumferential axis of the rod assembly such that at least one finger of the plurality of fingers contacts the first electrical connector throughout a rotational range of motion of the body about the rod assembly,
wherein the rotational range of motion of the body about the rod assembly corresponds to a motion of the body between the deployed position and the storage position when the rod assembly is coupled to a structure of the vehicle.

2. The vehicle sun visor of claim 1, wherein the plurality of fingers comprises a first finger and a second finger,
wherein the first finger and the second finger are positioned on opposite sides of the first electrical connector.

3. The vehicle sun visor of claim 1, wherein at least one finger of the plurality of fingers has a protrusion configured to contact the first electrical connector.

4. The vehicle sun visor of claim 1, wherein the plurality of fingers of the second electrical connector are formed from a single piece of electrically conductive material.

5. The vehicle sun visor of claim 1, wherein the rod assembly comprises an arm and a cap coupled to the arm, and
wherein the first electrical connector is coupled to the cap.

6. The vehicle sun visor of claim 1, wherein the first electrical connector is molded to the rod assembly.

7. The vehicle sun visor of claim 1, comprising an electrical wire electrically coupled to the first electrical connector and extending through the rod assembly.

8. The vehicle sun visor of claim 1, wherein the rod assembly has a recess, and
wherein the first electrical connector is disposed within the recess.

9. The vehicle sun visor of claim 8, wherein the recess is formed from a pair of opposing circumferential ridges, and
wherein at least one of the pair of opposing circumferential ridges has a gap.

10. The vehicle sun visor of claim 9, wherein the first electrical connector has a longitudinal extension, and
wherein the longitudinal extension extends through the gap.

11. The vehicle sun visor of claim 8, wherein the rod assembly comprises an arm and a cap coupled to the arm, and
wherein the recess if formed within the cap.

12. The vehicle sun visor of claim 11, wherein a polymeric material is molded over the cap without covering an outer peripheral surface of the first electrical connector.

13. The vehicle sun visor of claim 1, wherein the first electrical connector is crimped to secure the first electrical connector to the rod assembly.
